(19) United States
(12) Patent Application Publication
(10) Pub. No.: US 2022/0381986 A1
(43) Pub. Date: Dec. 1, 2022

(54) OPTICAL BRIDGE WAVEGUIDE FOR HETEROGENEOUS INTEGRATION AND METHOD OF FORMING SAME

(71) Applicant: Teledyne Scientific & Imaging, LLC, Thousand Oaks, CA (US)

(72) Inventors: Adam Young, Thousand Oaks, CA (US); Andy Carter, Thousand Oaks, CA (US)

(21) Appl. No.: 17/826,032

(22) Filed: May 26, 2022

Related U.S. Application Data
(60) Provisional application No. 63/194,089, filed on May 27, 2021.

(51) Int. Cl. G02B 6/136; G02B 6/122; G02B 6/43; G02B 6/12

(52) U.S. Cl. CPC G02B 6/136; G02B 6/1221; G02B 6/43; G02B 6/12004

(57) ABSTRACT

A method of forming an optical bridge waveguide between an optical element and an optical waveguide layer fabricated on a substrate such as a PIC platform. An optical element is heterogeneously integrated on the substrate. A first dielectric layer is deposited on the substrate and etched to a predetermined height. A second dielectric layer having a higher k than the first dielectric layer is deposited on the first dielectric layer, and a third dielectric layer having a lower k than the second dielectric layer is deposited on the second dielectric layer. The dielectric layers are formed such that the second dielectric layer provides an optical bridge waveguide between the optical element and optical waveguide layer, with the first and third dielectric layers providing a lower and upper cladding, respectively, for the optical bridge waveguide.

### RELATED APPLICATIONS

This application claims the benefit of provisional patent application No. 63/194,089 to A. Young and A. Carter, filed May 27, 2021.

### BACKGROUND OF THE INVENTION

### Field of the Invention

This invention relates generally to optical waveguides, and more particularly to bridge waveguides capable of interconnecting optical elements.

### Description of the Related Art

A substrate may include an optical waveguide layer, which is to be optically coupled to one or more optical elements mounted to the substrate. For example, a photonic integrated circuit (PIC) platform may have an optical element such as a semiconductor laser heterogeneously integrated onto it, with light from the laser needing to be coupled to the platform's optical waveguide layer. However, coupling light from an optical element to an optical waveguide layer is difficult to do efficiently. Very small gaps are required to achieve good coupling efficiency, due to large divergence in the optical beam when it is not being guided (i.e., in the gap between the optical element and the optical waveguide layer).

### SUMMARY OF THE INVENTION

A method of forming an optical bridge waveguide between an optical element and an optical waveguide layer fabricated on a substrate is presented, which allows for minimal gaps between the bridge waveguide, optical element, and optical waveguide layer.

The present method comprises providing coupling between an optical element and a substrate on which an optical waveguide layer has been fabricated, such as a PIC platform. An optical element is heterogeneously integrated on the substrate, preferably using a technique such as micro-transfer printing (MTP). A first dielectric layer is deposited on the substrate between the optical element and optical waveguide layer, and etched to a predetermined height on the substrate. A second dielectric layer having a higher k than the first dielectric layer is deposited on the first dielectric layer, and a third dielectric layer having a lower k than the second dielectric layer is deposited on the second dielectric layer. The dielectric layers are formed such that the second dielectric layer provides an optical bridge waveguide between the optical element and optical waveguide layer, with the first and third dielectric layers providing a lower and upper cladding, respectively, for the optical bridge waveguide.

The heterogeneously integrated optical element typically includes one or more waveguides (input and/or output), with the optical bridge waveguide formed to couple the optical element's waveguides to the optical waveguide layer. The widths of the optical element's waveguide and the optical waveguide layer may be approximately equal, and the second dielectric layer may be patterned and etched such that the width of the optical bridge waveguide is approximately equal to those widths. The optical bridge waveguide preferably has a nominal width of less than half a wavelength. One or more vias may be etched in the third dielectric layer, and the second dielectric layer if required, and a metallization layer deposited which makes contact to at least the optical element through the one or more vias.

These and other features, aspects, and advantages of the present invention will become better understood with reference to the following drawings, description, and claims.

### BRIEF DESCRIPTION OF THE DRAWINGS

FIG. 1 is a plan view of an optical bridge waveguide as it might be used to couple an optical element with a PIC platform.

FIG. 2 is a sectional view of the arrangement shown in FIG. 1, cut along section line A-A.

FIG. 3 is a sectional view of the arrangement shown in FIG. 1, cut along section line B-B.

FIG. 4 is a sectional view illustrating a step of forming an optical bridge waveguide in accordance with one possible embodiment of the present method.

FIG. 5 is a sectional view illustrating another step of forming an optical bridge waveguide in accordance with one possible embodiment of the present method.

FIG. 6 is a sectional view illustrating another step of forming an optical bridge waveguide in accordance with one possible embodiment of the present method.

FIG. 7 is a sectional view illustrating another step of forming an optical bridge waveguide in accordance with one possible embodiment of the present method.

FIG. 8 is a sectional view illustrating another step of forming an optical bridge waveguide in accordance with one possible embodiment of the present method.

### DETAILED DESCRIPTION OF THE INVENTION

The present method of forming an optical bridge waveguide serves to provide an efficient optical interconnect/bridge between a heterogeneously integrated optical element and an optical waveguide layer fabricated on a substrate. The primary application of the bridge waveguide is to couple an optical element such as, for example, a semiconductor laser, to an optical waveguide layer fabricated on a substrate such as, for example, a PIC platform.

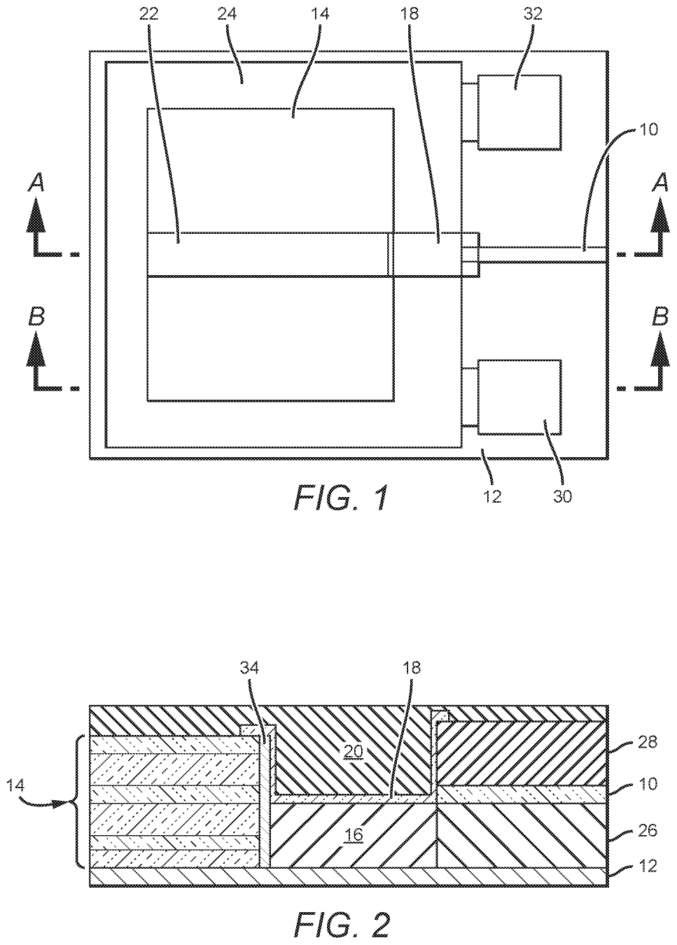

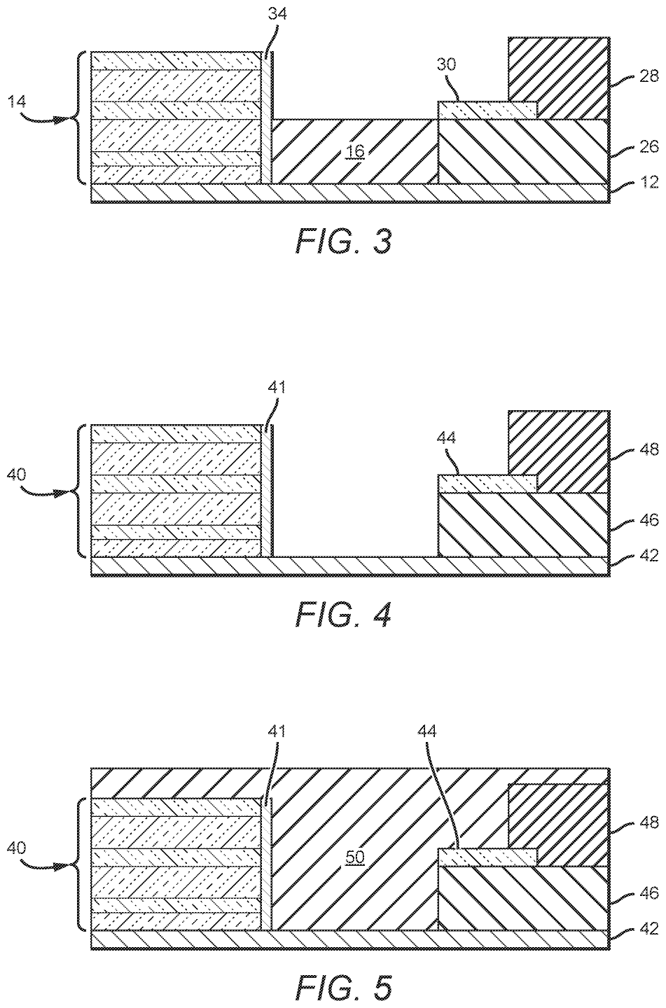

The general concepts of an optical bridge waveguide as described herein are illustrated in the simplified plan view shown in FIG. 1, along with the cross-sectional views shown in FIG. 2 (cut along section line A-A) and FIG. 3 (cut along section line B-B). As shown in FIGS. 1-3, an optical waveguide layer 10 has been fabricated on a substrate 12. An optical element 14 is mounted on substrate 12. A first dielectric layer 16 is deposited on substrate 12 between optical element 14 and optical waveguide layer 10, which has a predetermined height. A second dielectric layer 18 having a higher k than the first dielectric layer is deposited on first dielectric layer 16. A third dielectric layer 20 is deposited on second dielectric layer 18 (layers 16 and 20 not shown in FIG. 1 for clarity).

Second dielectric layer 18 is arranged to provide an optical bridge waveguide between optical element 14 and optical waveguide layer 10, with first dielectric layer 16 and third dielectric layer 20 providing a lower and upper cladding, respectively, for the optical bridge waveguide. Optical element 14 would typically have one or more input and/or output waveguides such as waveguide 22, with optical bridge waveguide 18 coupling optical element waveguide 22 to optical waveguide layer 10. Substrate 12 may include an etched recess 24, into which optical element 14 may be mounted.

Optical element waveguide 22 has a first width at its interface with optical bridge waveguide 18, optical waveguide layer 10 has a second width at its interface with optical bridge waveguide 18 , and optical bridge waveguide 18 has a third width. In one embodiment, the first, second, and third widths are approximately equal. Note that these widths are not necessarily constant, and one or more of them could include a taper.

The optical waveguide layer fabricated on a substrate is suitably a photonic integrated circuit (PIC) platform. Such a platform might include substrate 12, with optical waveguide layer 10 sandwiched between dielectric layers 26 and 28, which are suitably SiO₂. The platform might also include pedestals 30, 32, suitably SiN, which can be used to provide endpoint detection when etching first dielectric layer 16 to the predetermined height (discussed in more detail below).

Optical element 14 can be, for example, a semiconductor laser (e.g., GaAs—, InP—, GaN— based) of different types (e.g., Fabry-Pérot, distributed feedback, distributed Bragg reflector, external cavity, mode locked, etc.), an amplifier (e.g., semiconductor optical amplifier (SOA)), a modulator (e.g., electro-optical modulator (phase and/or amplitude)), optical attenuator, photodiode, a non-linear device (e.g. harmonic generation, four-wave mixing, etc.), or other functional optical element. Optical element 14 may comprise multiple device layers (as shown) and/or a passivation layer 34 between the element and dielectric layers 16 and 20, though other structures are possible. More than one optical bridge waveguide may be fabricated as described herein and employed between optical element 14 and optical waveguide layer 10.

An optical bridge waveguide as described herein provides significantly improved coupling efficiency, increased gap length, and deceased sensitivity to gap length, in that it reduces the unguided distance between an optical element and, for example, a PIC waveguide. Assuming an optical element and a PIC platform with respective waveguides to be coupled, the “gap length” is the distance between the optical element waveguide edge to the PIC waveguide edge. In the case of a laser, for example, light diverges as it leaves the laser and forms a cone of light. Only the portion of the light in the cone that intersects the optical waveguide in the PIC platform is captured. If the light is allowed to diverge significantly, the amount of coupled light is small. To prevent the light from diverging significantly, the gap must be made very small. However, the use of an optical bridge waveguide as described herein between the optical element and PIC waveguides prevents the light from diverging. If the light cannot diverge, there is little sensitivity to gap distance. Thus, by adding an optical bridge waveguide, the unguided distance the light travels is reduced or eliminated, and is effectively decoupled from the physical gap between the two components.

Another advantage of the present optical bridge waveguide is that it enables heterogenous integration of an optical element, using MTP for example, which provides an improved thermal environment and improved alignment relative to a flip chip PIC platform. This allows integration with more platforms, such as a low loss SiN PIC platform. A low temperature fabrication path is also provided.

One possible process sequence for forming an optical bridge waveguide in accordance with the present invention is shown in FIGS. 4-8; note the sectional views shown in FIGS. 4-6 are equivalent to that shown in FIG. 3 taken along the section line B-B, while the sectional views shown in FIGS. 7-8 are equivalent to that shown in FIG. 2 taken along the section line A-A. In FIG. 4, an optical element 40 (possibly including a passivation layer 41) and a substrate 42 on which an optical waveguide layer (not visible in FIGS. 4-6) has been fabricated are provided, and the optical element 40 is heterogeneously integrated on the substrate. A preferred method of integrating optical element 40 onto substrate 42 is micro-transfer printing (MTP). Substrate 42 with optical waveguide layer and, optionally, a pedestal 44 may be provided prefabricated. The optical waveguide layer would be formed on and covered by dielectric layers 46 and 48, typically SiO₂. As noted above, optical element 40 may be integrated within an etched recess (not shown in FIG. 4) in substrate 42.

In FIG. 5, a first dielectric layer 50 is deposited on substrate 42 between optical element 40 and the optical waveguide layer. Dielectric layer 50 is preferably deposited by spin coating, for planarization, gap filling, and to provide a lower cladding for the optical bridge waveguide. Dielectric layer 50 should have low optical loss at the wavelength of interest; a preferred material for the first dielectric layer comprises polymer benzocyclobutene (BCB).

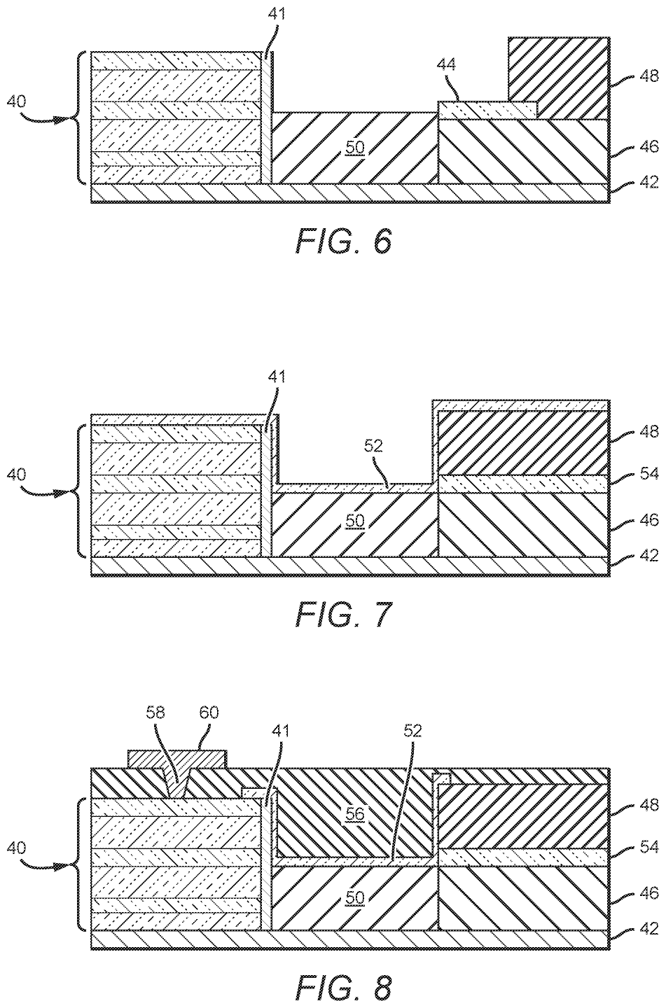

In FIG. 6, first dielectric layer 50 is etched back to a predetermined height on substrate 42. The predetermined height is established by the desired height of the optical bridge waveguide, which should be close to the heights of the waveguides to be coupled. A pedestal 44 could be used to perform endpoint detection to etch first dielectric layer 50 to the predetermined height.

In FIG. 7, a second dielectric layer 52 having a higher k than first dielectric layer 50 is deposited on the first dielectric layer; one preferred material for second dielectric layer 52 is SiN. Second dielectric layer 52 is preferably deposited by spin coating, sputter coating, or evaporative coating. An optical waveguide layer 54 on substrate 42—suitably SiN—is visible in the sectional view shown in FIG. 7. Second dielectric layer 52 is arranged to provide an optical bridge waveguide between optical element 40 and optical waveguide layer 54.

Second dielectric layer 52 would typically be blanket deposited, and then optionally patterned and etched to give the optical bridge waveguide a desired shape. For example, optical element 40 may have a waveguide having a first width and optical waveguide layer 54 may have a second width; second dielectric layer 52 could be patterned and etched such that the width of the optical bridge waveguide is approximately the same as the first and second widths. A wavelength range of at least 400-4000 nm is contemplated, with the majority of use at 1000, 1330, and 1550 nm. If needed, the optical bridge waveguide can be formed with a slope, to couple waveguides having different heights; this might be accomplished using grey-scale lithography. If needed, the optical bridge waveguide can be fabricated with a taper, to couple to waveguides having different widths; this might be accomplished during the optional patterning and etching steps. The second dielectric layer 52 would typically be removed from all areas not being used for the optical bridge; this might be accomplished during the optional patterning and etching steps.

In FIG. 8, a third dielectric layer 56 is deposited on second dielectric layer 52. Dielectric layer 56 is preferably deposited by spin coating, for planarization, gap filling, and to provide an upper cladding for the optical bridge waveguide. As with first dielectric layer 50, third dielectric layer 56 should have low optical loss at the wavelength of interest; a preferred material for the third dielectric layer comprises polymer benzocyclobutene (BCB). The third dielectric layer 56 could be optionally removed from all areas outside of the optical bridge, using either optional patterning and etching steps or chemical mechanical polishing.

One or more vias 58 may be etched in third dielectric layer 56, and second dielectric layer 52 if required, and a metallization layer 60 may be deposited over the structure which makes contact to at least optical element 40 through the one or more vias.

As previously noted, the optical waveguide layer fabricated on a substrate may be a PIC platform. Additional optical bridge waveguides may be formed as described herein and used to, for example, couple optical element 40 with optical waveguide layer 54.

The embodiments of the invention described herein are exemplary and numerous modifications, variations and rearrangements can be readily envisioned to achieve substantially equivalent results, all of which are intended to be embraced within the spirit and scope of the invention as defined in the appended claims.

We claim:

1. A method of forming an optical bridge waveguide between an optical element and an optical waveguide layer fabricated on a substrate, comprising:
providing an optical element;
providing a substrate on which an optical waveguide layer has been fabricated;
heterogeneously integrating said optical element on said substrate;
depositing a first dielectric layer on said substrate between said optical element and said optical waveguide layer;
etching said first dielectric layer to a predetermined height on said substrate;
depositing a second dielectric layer having a higher k than said first dielectric layer on said first dielectric layer;
depositing a third dielectric layer having a lower k than said second dielectric layer on said second dielectric layer;
such that said second dielectric layer provides an optical bridge waveguide between said optical element and said optical waveguide layer, with said first and third dielectric layers providing a lower and upper cladding, respectively, for said optical bridge waveguide.

2. The method of claim 1, wherein said optical element is heterogeneously integrated on said substrate using micro-transfer printing (MTP).

3. The method of claim 1, wherein said first dielectric layer comprises polymer benzocyclobutene (BCB).

4. The method of claim 1, wherein said second dielectric layer comprises SiN.

5. The method of claim 1, wherein said third dielectric layer comprises polymer benzocyclobutene (BCB).

6. The method of claim 1, wherein said first and third dielectric layers are deposited by spin coating.

7. The method of claim 1, wherein said second dielectric layer is deposited by spin coating, sputter coating, or evaporative coating.

8. The method of claim 1, wherein said substrate includes an etched recess, said optical element mounted in said etched recess.

9. The method of claim 1, wherein said optical element has a waveguide, said optical bridge waveguide coupling said optical element's waveguide to said optical waveguide layer.

10. The method of claim 1, wherein said optical element has a waveguide having a first width, and said optical waveguide layer has a second width, said first and second widths being approximately equal, further comprising:
patterning and etching said second dielectric layer such that the width of said optical bridge waveguide is approximately the same as said first and second widths.

11. The method of claim 1, further comprising:
etching one or more vias in said third dielectric layer; and
depositing a metallization layer which makes contact to at least said optical element through said one or more vias.

12. The method of claim 11, further comprising etching one or more vias in said second dielectric layer prior to depositing said metallization layer.

13. The method of claim 1, wherein said optical waveguide layer fabricated on a substrate is a photonic integrated circuit (PIC) platform.

14. The method of claim 1, wherein endpoint detection is used to etch said first dielectric layer to said predetermined height.

15. The method of claim 1, further comprising forming additional ones of said optical bridge waveguides which couple said optical element with sad optical waveguide layer.

16. An optical bridge waveguide for coupling an optical element to an optical waveguide layer fabricated on a substrate, comprising:
a substrate on which an optical waveguide layer has been fabricated;
an optical element on said substrate;
a first dielectric layer on said substrate between said optical element and said optical waveguide layer, said first dielectric layer having a predetermined height;
a second dielectric layer having a higher k than said first dielectric layer on said first dielectric layer;
a third dielectric layer having a lower k than said second dielectric layer on said second dielectric layer;
said second dielectric layer arranged to provide an optical bridge waveguide between said optical element and said optical waveguide layer, with said first and third dielectric layers providing a lower and upper cladding, respectively, for said optical bridge waveguide.

17. The optical bridge waveguide of claim 16, wherein said optical element is heterogeneously integrated on said substrate.

18. The optical bridge waveguide of claim 16, wherein said first dielectric layer comprises polymer benzocyclobutene (BCB).

19. The optical bridge waveguide of claim 16, wherein said second dielectric layer comprises SiN.

20. The optical bridge waveguide of claim 16, wherein said third dielectric layer comprises polymer benzocyclobutene (BCB).

21. The optical bridge waveguide of claim 16, wherein said substrate includes an etched recess, said optical element mounted in said etched recess.

22. The optical bridge waveguide of claim 21, wherein said optical element has a waveguide, said optical bridge waveguide coupling said optical element's waveguide to said optical waveguide layer.

23. The optical bridge waveguide of claim 16, wherein said optical element has a waveguide having a first width, said optical waveguide layer has a second width, and said optical bridge waveguide has a third width, said first, second, and third widths being approximately equal.

24. The optical bridge waveguide of claim 16, further comprising:
one or more vias in said third dielectric layer; and
a metallization layer which makes contact to at least said optical element through said one or more vias.

25. The optical bridge waveguide of claim 24, further comprising one or more vias in said second dielectric layer.

26. The optical bridge waveguide of claim 16, wherein said optical waveguide layer fabricated on a substrate is a photonic integrated circuit (PIC) platform.

27. The optical bridge waveguide of claim 16, wherein said optical element comprises a laser, amplifier, modulator, or other functional optical element.

28. The optical bridge waveguide of claim 16, further comprising additional ones of said optical bridge waveguides between said optical element and said optical waveguide layer.
